(19) United States
(12) Patent Application Publication
(10) Pub. No.: US 2025/0153556 A1
(43) Pub. Date: May 15, 2025

(54) HYBRID TRANSMISSION, DRIVE TRAIN FOR A HYBRID VEHICLE, AND METHOD FOR OPERATING A DRIVE TRAIN

(71) Applicant: Schaeffler Technologies AG & Co. KG, Herzogenaurach (DE)

(72) Inventors: Steffen Lehmann, Ettlingen (DE); Dominik Hans, Muggensturm (DE)

(73) Assignee: Schaeffler Technologies AG & Co. KG, Herzogenaurach (DE)

(21) Appl. No.: 18/839,457

(22) PCT Filed: Dec. 14, 2022
(86) PCT No.: PCT/DE2022/100952

§ 371 Date: Aug. 19, 2024

(30) Foreign Application Priority Data
Feb. 24, 2022 (DE) 10 2022 104 376.2

(51) Int. Cl. B60K 6/547; B60K 6/26; B60K 6/365; B60K 6/387; B60K 6/442; F16H 37/08; F16H 63/18; F16H 63/30; F16H 63/34

(52) U.S. Cl. CPC B60K 6/547; B60K 6/26; B60K 6/365; B60K 6/387; B60K 6/442; F16H 37/0806; F16H 63/18; F16H 63/3013; F16H 63/3416; B60Y 2200/91; F16H 2200/0034

(57) ABSTRACT

A hybrid transmission includes a first drive shaft, a second drive shaft, an output side and a first torque transmission path extending between the first drive shaft and the output side. The first torque transmission path comprises a first transmission means, wherein the first transmission means comprises a shifting means, a first transmission stage with a first transmission ratio and a second transmission stage with a second transmission ratio different from the first transmission ratio. In a first shifting state of the shifting means, the shifting means connects the first drive shaft to the first transmission stage, and the first transmission stage couples the first drive shaft to the output side. In a second shifting state of the shifting means different from the first shifting state, the shifting means connects the first drive shaft to the second transmission stage, and the second transmission stage couples the first drive shaft to the output side.

### CROSS-REFERENCE TO RELATED APPLICATIONS

This application is the U.S. National Phase of PCT Appln. No. PCT/DE2022/100952 filed Dec. 14, 2022, which claims priority to DE 10 2022 104 376.2 filed Feb. 24, 2022, the entire disclosures of which are incorporated by reference herein.

### TECHNICAL FIELD

The disclosure relates to a hybrid transmission for a drive train of a hybrid vehicle and a method for operating the drive train.

### BACKGROUND

A drive unit for a drive train of a hybrid motor vehicle having an internal combustion engine, a first electric machine, and a second electric machine is known from WO 2019/105504 A1.

### SUMMARY

It is the object of the disclosure to provide an improved hybrid transmission, an improved drive train, and an improved method for operating the drive train.

This object is achieved by means of a hybrid transmission described in the disclosure, drawings and claims. Advantageous embodiments are provided herein.

It has been recognized that an improved hybrid transmission for a drive train of a hybrid vehicle can be provided by the hybrid transmission having a first drive shaft, a second drive shaft, an output side, and a first torque transmission path extending between the first drive shaft and the output side. The first torque transmission path has a first transmission means. The first drive shaft can be connected in a rotationally fixed manner to a first rotor of a first electric machine and in a torque-locking manner to a crankshaft of an internal combustion engine. The second drive shaft can be connected in a rotationally fixed manner to a second rotor of a second electric machine. The first transmission means has a shifting means, a first transmission stage with a first transmission ratio, and a second transmission stage with a second transmission ratio different from the first transmission ratio. In a first shifting state of the shifting means, the shifting means connects the first drive shaft to the first transmission stage and the first transmission stage couples the first drive shaft to the output side. In a second shifting state of the shifting means different from the first shifting state, the shifting means connects the first drive shaft to the second transmission stage, and the second transmission stage couples the first drive shaft to the output side.

This embodiment has the advantage that the hybrid transmission is designed as particularly simple and compact. Furthermore, the number of components can be kept to a minimum. Due to the transmission gearing with two transmission stages, the internal combustion engine connected to the first drive shaft can be operated in a particularly fuel-efficient manner. Furthermore, different possibilities for operating the drive train are also possible so that the drive train can be operated as a serial as well as parallel hybrid.

In a further embodiment, the shifting means has a first clutch, in particular a first form-fit clutch, in particular a first claw clutch, and a second clutch, in particular a second form-fit clutch, in particular a second claw clutch. In the first shifting state, the first clutch is engaged and connects the first drive shaft to the first transmission stage in a torque-locking manner, preferably in a rotationally fixed manner. In the first shifting state, the second clutch is furthermore disengaged. In the second shifting state, the second clutch is engaged and connects the first drive shaft to the second transmission stage in a torque-locking manner, preferably in a rotationally fixed manner. In the second shifting state, the first clutch is disengaged. By alternately disengaging and engaging the clutch, it is thus possible to switch between the first transmission stage and the second transmission stage.

It is particularly advantageous if the shifting means has an electrically and/or hydraulically actuated actuator, a shift drum connected to the actuator, an actuating link and at least a first shift linkage. The actuating link has a first link arranged on the shift drum and at least one first link block arranged on the first link and connected to the shift linkage. The first link block is coupled to the first clutch by means of the first shift linkage. The shift drum is arranged so as to be rotatable about a drum axis, wherein, in the second shifting state, the shift drum is rotated relative to the first shifting state. The advantage of this embodiment is that a single actuator can be used to actuate the shifting means, and possibly also a further separating clutch and/or a parking lock, in a simple manner. Furthermore, the actuator can, in particular, be electrically actuated so that a hydraulic system can be dispensed with.

In a further embodiment, the hybrid transmission has a second torque transmission path extending between the second drive shaft and the output side with a second transmission means and a separating clutch, wherein the separating clutch is arranged between the second transmission means and the output side. In a disengaged state of the separating clutch, the separating clutch separates the output side from the second transmission means. In an engaged state of the separating clutch, the separating clutch connects the second transmission means to the output side in a torque-locking manner, preferably in a rotationally fixed manner.

In a further embodiment, the first drive shaft is mounted rotatably about a first axis of rotation, wherein the first transmission means has a first idler gear mounted rotatably about the first axis of rotation and a second idler gear mounted rotatably about the first axis of rotation. The shifting means is arranged axially relative to the first axis of rotation between the first idler gear and the second idler gear. In the engaged state, the first clutch connects the first drive shaft to the first idler gear in a torque-locking manner, preferably in a rotationally fixed manner. In the engaged state, the second clutch connects the second idler gear to the first drive shaft in a torque-locking manner, preferably in a rotationally fixed manner. This embodiment has the advantage that the installation space requirement is particularly low. In particular, the first and second transmission stages can also be kept short in the radial direction.

In a further embodiment, the first transmission means has an intermediate shaft mounted rotatably about a second axis of rotation extending parallel to the first axis of rotation, a first fixed gear and a second fixed gear, wherein the first fixed gear and the second fixed gear are each connected in a rotationally fixed manner to the intermediate shaft. The first idler gear and the first fixed gear engage with one another in a meshing manner. The second idler gear and the second fixed gear engage with one another in a meshing manner. The arrangement of the two fixed gears on the intermediate shaft has the advantage that the hybrid transmission is structured in a particularly simple manner.

In a further embodiment, the hybrid transmission has a parking lock and a housing. The parking lock can be set to a disengaged state and an engaged state. In the engaged state, the parking lock connects the second drive shaft to the housing and blocks a rotation of the second drive shaft. In the disengaged state of the parking lock, the second drive shaft is rotatable about a third axis of rotation.

An improved drive train for a hybrid vehicle can be provided in that the drive train has a hybrid transmission, a first electric machine with a first rotor and a second electric machine with a second rotor. The hybrid transmission is designed as described above. The first drive shaft can be coupled to a crankshaft of an internal combustion engine. The first drive shaft is connected in a rotationally fixed manner to the first rotor and the second drive shaft is connected in a rotationally fixed manner to the second rotor. Preferably, the first transmission means is arranged between the first rotor and the second rotor.

This embodiment has the advantage that due to the arrangement of the transmission means between the first and second rotors, the first and second electric machines are arranged at a distance from one another and the transmission means can therefore be simple in terms of design.

An improved method for operating a drive train can be provided by providing the drive train described above. A first drive power is introduced into the first drive shaft. The first electric machine is operated as a generator by means of a first portion of the first drive power for generating electrical energy. The shifting means is set to the first shifting state. A second portion of the first drive power is transmitted to the output side via the first transmission stage. Alternatively, the shifting means is set to the second shifting state, wherein a second portion of the first drive power is transmitted to the output side via the second transmission stage.

In a further embodiment, the second electric machine introduces a second drive power into the second drive shaft, wherein the second drive power is transmitted to the output side via the second torque transmission path, wherein the second portion of the first drive power and the second drive power are provided at the output side for driving the vehicle.

### BRIEF DESCRIPTION OF THE DRAWINGS

The disclosure is explained in more detail below with reference to figures. In the figures:

FIG. 1 shows a schematic representation of a drive train according to a first embodiment,

FIG. 2 shows a sectional view through a structural embodiment of the drive train 10 shown in FIG. 1,

FIG. 3 shows a section A marked in FIG. 1 of the schematic representation of the drive train shown in FIG. 1,

FIG. 4 shows the drive train 10 shown in FIG. 1 in a first operating state,

FIG. 5 shows a diagram showing the respective states of the first and second clutch, the parking lock and the separating clutch,

FIG. 6 shows the schematic structure of the drive train shown in FIG. 1 in a second operating state,

FIG. 7 shows the state of the parking lock, the first and second clutch, and the separating clutch in a symbolized manner,

FIG. 8 shows a section B shown in FIG. 6 of the schematic representation of the drive train shown in FIG. 6 during a second operating state,

FIG. 9 shows the structure of the drive train shown in FIG. 1 in a third operating state,

FIG. 10 shows the state of the parking lock, the first and second clutch, and the separating clutch in a symbolized manner,

FIG. 11 shows a section C marked in FIG. 9 of the drive train shown in FIG. 9 in the third operating state,

FIG. 12 shows the drive train shown in FIG. 1 in a fourth operating state,

FIG. 13 shows the state of the parking lock, the first and second clutch, and the separating clutch in the fourth operating state in a symbolized manner,

FIG. 14 shows a section D marked in FIG. 12 of the drive train shown in FIG. 12 in the fourth operating state,

FIG. 15 shows the schematic representation of the drive train shown in FIG. 1 in a fifth operating state,

FIG. 16 shows a schematic representation of the state of the parking lock, the first and second clutch, and the separating clutch,

FIG. 17 shows a section E marked in FIG. 15 of the drive train shown in FIG. 15,

FIG. 18 shows a schematic representation of a drive train according to a second embodiment and

FIG. 19 shows a sectional view through a structural embodiment of the drive train shown in FIG. 15.

### DETAILED DESCRIPTION

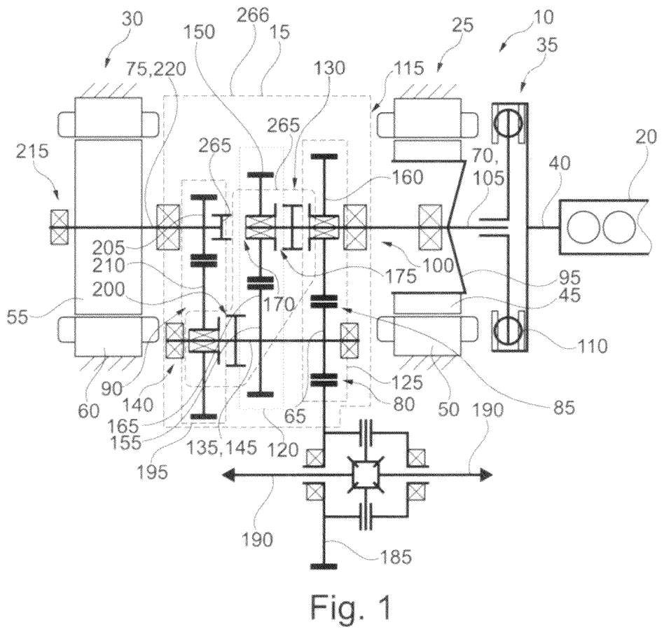

FIG. 1 shows a schematic representation of a drive train 10 according to a first embodiment.

The drive train 10 has a hybrid transmission 15, an internal combustion engine 20, a first electric machine 25, a second electric machine 30, a differential 65 and preferably a damper system 35.

The internal combustion engine 20 has a crankshaft 40 on the output side. The first electric machine 25 has a first rotor 45 and a first stator 50. In the embodiment, the first electric machine 25 is, by way of example, designed as an internal rotor, so that the first stator 50 surrounds the first rotor 45 on the circumference, for example. The second electric machine 30 has a second rotor 55 and a second stator 60. In the embodiment, the second electric machine 30 is, by way of example, designed as an internal rotor, so that the second stator 60 surrounds the second rotor 55 on the circumference, for example.

The hybrid transmission 15 has a first drive shaft 70, a second drive shaft 75, an output side 80, a first torque transmission path 85 extending between the first drive shaft 70 and the output side 80, a second torque transmission path 90 extending between the second drive shaft 75 and the output side 80, preferably a rotor carrier 95, a parking lock 265, and a housing 266.

The first drive shaft 70 is connected in a rotationally fixed manner to a rotor carrier 95, wherein the rotor carrier 95 carries the first rotor 45 on the outside and is connected in a rotationally fixed manner to the first rotor 45. In this context, the term “rotationally fixed” is understood to mean that two components, for example the first drive shaft 70 and the rotor carrier 95, rotate at the same rotational speed and torque can be transmitted. The first drive shaft 70 is mounted rotatably about a first axis of rotation 105 by means of a first bearing arrangement 100. The first drive shaft 70 forms a first input side of the hybrid transmission 15. The first drive shaft 70 is arranged on the side facing the internal combustion engine 20 and is preferably connected in a torque-locking manner to the crankshaft 40 via the damper system 35. The damper system 35 can, for example, have a torsional damper so that the crankshaft 40 can be rotated about the first axis of rotation 105 against the action of a spring element 110 of the damper system 35 relative to the first drive shaft 70. The second drive shaft 75 is connected in a rotationally fixed manner, preferably directly, to the second rotor 55. The second drive shaft 75 forms a second input side of the hybrid transmission 15.

The first torque transmission path 85 has a first transmission means 115 with a first transmission stage 120, a second transmission stage 125, a shifting means 130, an intermediate shaft 135, and a second bearing arrangement 140.

The intermediate shaft 135 is arranged parallel to the first drive shaft 70 and is arranged rotatably about a second axis of rotation 145 by means of the second bearing arrangement 140.

The first transmission stage 120 has a first idler gear 150 and a first fixed gear 155. The first idler gear 150 is arranged rotatably about the first axis of rotation 105 on the first drive shaft 70. The first fixed gear 155 is arranged in a rotationally fixed manner on the intermediate shaft 135.

The second transmission stage 125 has a second idler gear 160 and a second fixed gear 165. The second idler gear 160 is arranged rotatably about the first axis of rotation 105 on the first drive shaft 70. The second idler gear 160 is preferably arranged at an axial distance from the first idler gear 150 with respect to the first axis of rotation 105. The second fixed gear 165 is arranged axially offset to the first fixed gear 155 in a rotationally fixed manner on the intermediate shaft 135.

In the embodiment, the first and second idler gears 150, 160 and the first and second fixed gears 155, 165 are designed as spur gears, for example. The first idler gear 150 engages with the first fixed gear 155 in a meshing manner. The first transmission stage 120 has a first transmission ratio. Analogous to the first transmission stage 120, the second idler gear 160 and the second fixed gear 165 engage with one another in a meshing manner. The second idler gear 160 is preferably designed to be geometrically different from the first idler gear 150, and the second fixed gear 165 is preferably designed to be different from the first fixed gear 155. The second transmission stage 125 has a second transmission ratio. The second transmission ratio is different from the first transmission ratio. In particular, the second transmission ratio is preferably longer than the first transmission ratio of the first transmission stage 120.

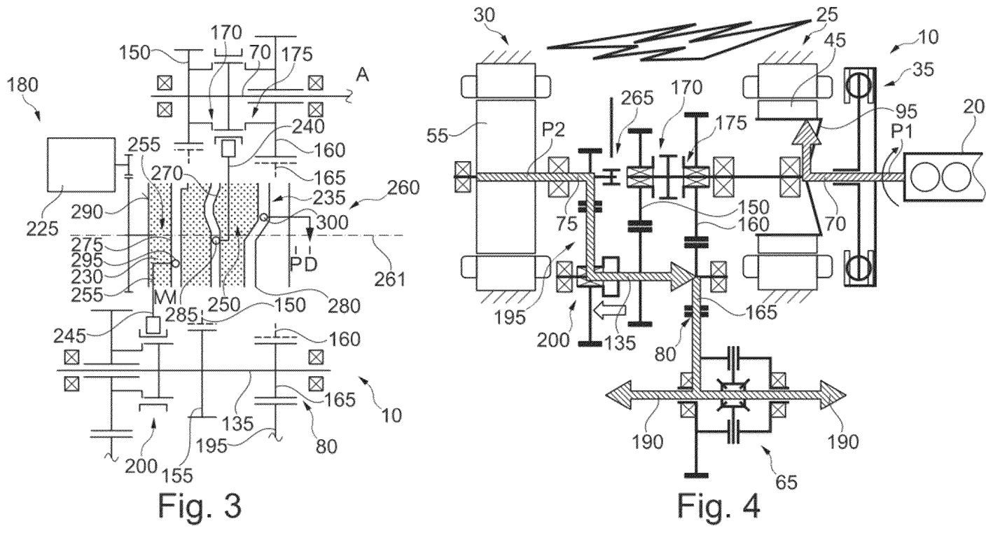

The shifting means 130 can be arranged axially between the first transmission stage 120 and the second transmission stage 125, at least in regions. The shifting means 130 has a first clutch 170, a second clutch 175, and an actuation unit 180. The actuation unit 180 is not shown in FIG. 1, wherein the actuation unit 180 is shown in detail in FIG. 3. The actuation unit 180 is mechanically connected to the first clutch 170 and to the second clutch 175 and is designed to actuate the first clutch 170 and the second clutch 175. The first clutch 170 can, for example, be designed as a first form-fit clutch, in particular as a first claw clutch, and the second clutch 175 can, for example, be designed as a second form-fit clutch, in particular as a second claw clutch. Alternatively, it would also be conceivable for the first clutch 170 and/or the second clutch 175 to have a friction clutch. The first clutch 170 and/or the second clutch 175 can also be synchronized.

The shifting means 130 has at least a first shifting state, a second shifting state, and preferably a third shifting state. In addition, the shifting means 130 can assume a fourth and/or fifth shifting state. In the first shifting state, which is assumed as an alternative to the second and third shifting states, the first clutch 170 is engaged and the second clutch 175 is disengaged. In the second shifting state, the second clutch 175 is engaged and the first clutch 170 is disengaged. In the third shifting state, the first clutch 170 and the second clutch 175 are disengaged.

In the first shifting state of the shifting means 130, the first clutch 170 is engaged. In the engaged state, the first clutch 170 connects the first drive shaft 70 to the first idler gear 150 in a torque-locking manner. In the embodiment, the first clutch 170 is, by way of example, designed as a first form-fit clutch, so that in the first shifting state, when the first clutch 170 is engaged, the first idler gear 150 is connected in a rotationally fixed manner to the first drive shaft 70. In order to enable engagement of the first clutch 170 from a disengaged state to an engaged state, the first clutch 170 can have a first synchronizing means. The first synchronizing means can, for example, comprise a pair of synchronizer rings. Furthermore, in the first shifting state, the second clutch 175 is disengaged so that the second idler gear 160 can be rotated relative to the first drive shaft 70. As a result, the first transmission stage 120 is engaged so that the first drive shaft 70 and the intermediate shaft 135 are connected to one another in a torque-locking manner in accordance with the first transmission ratio of the first transmission stage 120.

In the second shifting state of the shifting means 130, the second clutch 175 is engaged. In the engaged state, the second clutch 175 connects the first drive shaft 70 to the second idler gear 160 in a torque-locking manner. In the embodiment, the second clutch 175 is, by way of example, designed as a second form-fit clutch so that in the second shifting state, when the second clutch 175 is engaged, the second idler gear 160 is connected in a rotationally fixed manner to the first drive shaft 70. In order to enable engagement of the second clutch 175 from a disengaged state to an engaged state, the second clutch 175 can have a second synchronizing means. The second synchronizing means can, for example, comprise a pair of synchronizer rings. Furthermore, in the second shifting state, the first clutch 170 is disengaged so that the second idler gear 160 can be rotated relative to the first drive shaft 70. In this manner, the second transmission stage 125 is engaged. In the second shifting state, the first drive shaft 70 is thus connected in a torque-locking manner to the intermediate shaft 135 via the second transmission stage 125 in accordance with the second transmission ratio.

In the third shifting state, the first clutch 170 and the second clutch 175 are preferably disengaged. In the third shifting state, the first idler gear 150 and the second idler gear 160 as well as the first drive shaft 70 can be rotated relative to one another about the first axis of rotation 105. The third shifting state can, for example, also be an intermediate position or neutral position between the first shifting state and the second shifting state. In the third shift position, neither of the two transmission stages 120, 125 is engaged.

The differential 65 is connected to the output side 80 of the hybrid transmission 15 by means of a differential gear 185. The differential gear 185 of the differential 65 engages with the second fixed gear 165 in a meshing manner, for example on a side facing away from the second idler gear 160. On the output side, the differential 65 is connected to at least two output shafts 190 for driving the drive wheels of the motor vehicle.

The second torque transmission path 90 extends between the second drive shaft 75 and the output side 80. In this regard, the intermediate shaft 135 and the second fixed gear 165 are also part of the second torque transmission path 90. In the embodiment, the second torque transmission path 90, by way of example, has a second transmission means 195 and preferably a separating clutch 200.

The second transmission means 195 is arranged between the separating clutch 200 and the second drive shaft 75. The separating clutch 200 is arranged between the intermediate shaft 135 and the second transmission means 195. The second transmission means 195 has a third transmission ratio, wherein the third transmission ratio is preferably lower than the first transmission ratio of the first transmission stage 120 and lower than the second transmission ratio of the second transmission stage 125.

The second transmission means 195 has a third fixed gear 205 and a third idler gear 210. The third idler gear 210 and the third fixed gear 205 are, by way of example, designed as spur gears and engage with one another in a meshing manner. The third fixed gear 205 is arranged in a rotationally fixed manner on the second drive shaft 75. The second drive shaft 75 and thus also the third fixed gear 205 are mounted rotatably about a third axis of rotation 220 by means of a third bearing arrangement 215. The third idler gear 210 is arranged on the intermediate shaft 135. The separating clutch 200 can be designed as a third form-fit clutch, for example as a third claw clutch, and in the engaged state connects the intermediate shaft 135 in a torque-locking manner, preferably in a rotationally fixed manner, to the third idler gear 210. Furthermore, the separating clutch 200 can be synchronized.

In the disengaged state of the separating clutch 200, the third idler gear 210 and the intermediate shaft 135 can be rotated relative to one another about the second axis of rotation 145. In the engaged state of the separating clutch 200, the third idler gear 210 is connected to the intermediate shaft 135 in a torque-locking manner, preferably in a rotationally fixed manner. As a result, the second rotor 55 of the second electric machine 30 is connected to the intermediate shaft 135 in a rotationally fixed manner via the second transmission means 195 and the separating clutch 200.

The intermediate shaft 135 forms the junction of the first torque transmission path 85 and the second torque transmission path 90. Via the intermediate shaft 135, the second drive shaft 75 is connected to the second fixed gear 165, on which the output side 80 is arranged.

The housing 266 is arranged in the vehicle in a fixed manner. The components of the hybrid transmission 15 are arranged in the housing 266. In the embodiment, the parking lock 265 is, by way of example, arranged axially between the first idler gear 150 and the third fixed gear 205 with the second drive shaft 75. The parking lock 265 engages in the second drive shaft 75 in the engaged state and connects the second drive shaft 75 to the housing 266 in a rotationally fixed manner. In the disengaged state of the parking lock 265, the parking lock 265 is released so that the second drive shaft 75 is decoupled from the housing 266.

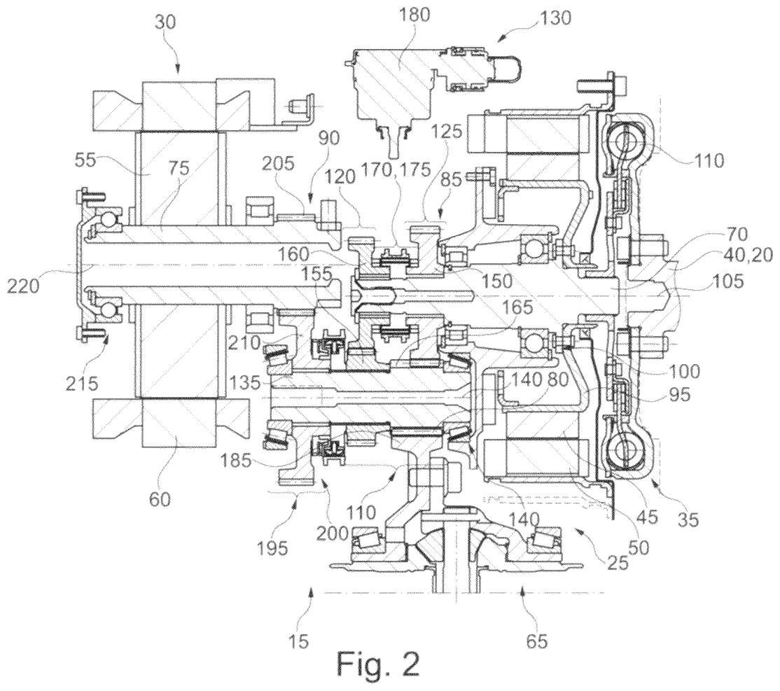

FIG. 2 shows a sectional view through a structural embodiment of the drive train 10 shown in FIG. 1.

By way of example, the intermediate shaft 135 and the second drive shaft 75 are designed as hollow shafts. The first drive shaft 70 is connected to the crankshaft 40 via a torsional damper of the damper system 35, which is, by way of example, designed in a simple manner in the embodiment. The first bearing arrangement 100 supports the first drive shaft 70 in such a way that the first drive shaft 70 is arranged parallel to the second drive shaft 75, which is mounted rotatably about the third axis of rotation 220 via the third bearing arrangement 215. In the embodiment, the first and second drive shafts 70, 75 are, by way of example, provided unsynchronized and designed as claw clutches, while the separating clutch 200, for example, has a third synchronizing means.

In the embodiment, the first fixed gear 155 is, by way of example, mounted in a rotationally fixed manner on the intermediate shaft 135, while the second fixed gear 165, for example, is a toothing section of the intermediate shaft 135, on the end face of which the mounted first fixed gear 155 can then be arranged. The third fixed gear 205 is also formed as a toothing section of the second drive shaft 75, so that the third fixed gear 205 and the second drive shaft 75 are formed integrally and of the same material. In order to ensure lubrication of the third bearing arrangement 215, in particular the bearing of the third bearing arrangement 215 arranged on the left-hand side in FIG. 2, it is particularly advantageous if the second drive shaft 75 is designed as a hollow shaft. Furthermore, this allows a rotating mass about the third axis of rotation 220 to be kept to a minimum.

FIG. 3 shows a section A marked in FIG. 1 of the schematic representation of the drive train 10 shown in FIG. 1.

The actuation unit 180 has an electrically and/or hydraulically actuated actuator 225, a shift drum 230, an actuating link 235, a first shift fork 240, preferably a second shift fork 245, at least a first shift linkage 250, a second shift linkage 255 and preferably a third shift linkage 260.

The actuator 225 is connected to the shift drum 230 in a rotationally fixed manner. The actuator 225 can rotate the shift drum 230 about a drum axis 261. The drum axis 261 can be aligned parallel to the first to third axis of rotation 105, 145, 220. The actuating link 235 is arranged on the shift drum 230 and has at least a first link 270. The first link 270 is associated with the first to third shifting states of the shifting means 130. In addition, a second link 275 of the actuating link 235 can be arranged on the shift drum 230 associated with the separating clutch 200. The second link 275 has a different shape to the first link 270 and extends substantially in the circumferential direction. The first and second links 270, 275 can be combined to form a common first and second link 270, 275.

Furthermore, the actuating link 235 on the shift drum 230 can have a third link 280. The third link 280 is, for example, associated with the parking lock 265. The first link 270, the second link 275 and the third link 280 can have a different shape. The first to third links 270, 275, 280 can each be designed as a cam disc with a circumferential control surface and/or end face control surface and/or be groove-shaped.

The first shift linkage 250 is connected at one side to the first shift fork 240. On the other side, the first shift linkage 250 is connected to a first link block 285, wherein the first link block 285 of the actuating link 235 engages in the first link 270. The first shift fork 240 is, in turn, connected to the first and second clutches 170, 175, in particular to a shift sleeve of the first and second clutches 170, 175. The first link 270 has a different shape and in particular is arranged at a distance from an end face 290 of the shift drum 230, depending on the shifting state of the shifting means 130 to be achieved.

The connection of the parking lock 265 and the separating clutch 200 is designed in the same way as the connection of the first and second clutches 170, 175 to the shift drum 230. A second link block 295 of the actuating link 235 rests against the second link 275 and is connected at one side to the second shift linkage 255. On the other side, the second shift linkage 255 is connected to the second shift fork 245, which actuates a sliding sleeve of the separating clutch 200.

A third link block 300 of the actuating link 235 rests against the third link 280. The third shift linkage 260 is connected on one side to the third link block 300 and actuates the parking lock 265.

The shift drum 230 can be rotated about the drum axis 261 in the circumferential direction. Depending on a drum position of the shift drum 230, which can be adjusted by the actuator 225, the individual shifting states are set. As a result, the first and second clutches 170, 175, the separating clutch 200, if present, and the parking lock 265 are each set by rotation of the shift drum 230.

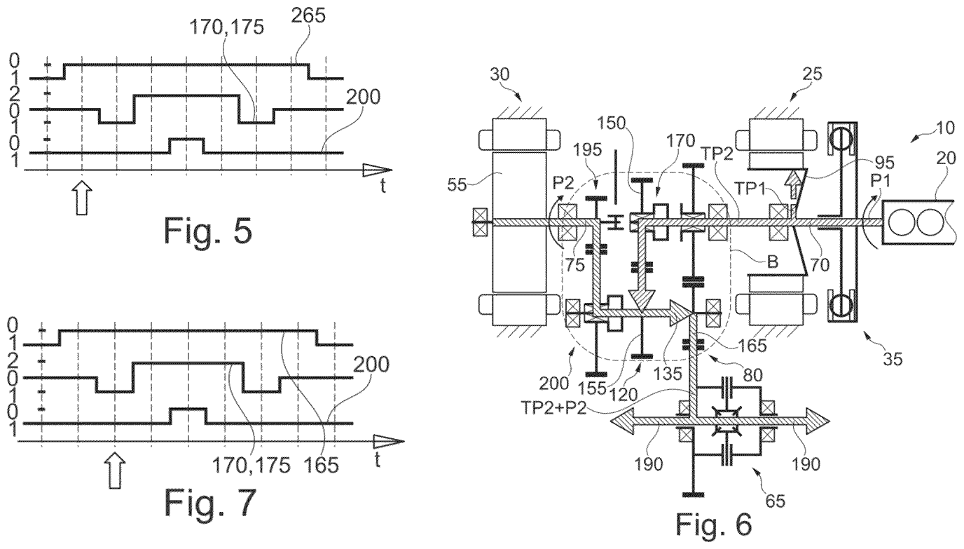

FIG. 4 shows the drive train 10 shown in FIG. 1 in a first operating state. FIG. 5 shows a diagram showing the respective states of the first and second clutch 170, 175, the parking lock 265 and the separating clutch 200.

Here, arrows are used in FIG. 4 to symbolize a power transmission. FIGS. 4 and 5 are explained together below. In FIG. 5, the state of the first and second clutches 170, 175, the parking lock 265 and the separating clutch 200 corresponding to FIG. 4 is symbolically marked by means of a thick arrow shown at the bottom.

In FIG. 5, the number 1 on the ordinate indicates the engaged/activated state of the first clutch 170, the parking lock 265 and the separating clutch 200 in each case. The number 0 indicates the disengaged/deactivated state of the first clutch 170, the second clutch 175, the parking lock 265, and the separating clutch 200 in each case. The number 2 indicates the engaged state of the second clutch 175.

In the first operating state, parking lock 265 is disengaged. The shifting means 130 is set to the third shift position. Furthermore, the separating clutch 200 is engaged in the third shifting state. In the first operating state, the internal combustion engine 20 is activated and provides a first drive power P1 at the crankshaft 40. The first drive power P1 can be provided with a rotational non-uniformity about the first axis of rotation at the crankshaft 40. The first drive power P1 is transmitted to the first drive shaft 70 via the damper system 35. The first drive shaft 70 drives the first rotor 45 of the first electric machine 25 via the rotor carrier 95. The first drive power P1 is transmitted in full via the rotor carrier 95 to the first electric machine 25, which is operated as a generator.

Due to the disengaged state of the first and second clutches 170, 175, the first drive shaft 70 can rotate freely relative to the first and second idler gears 150, 160. In the first operating state, the first electric machine 25 is operated as a generator, wherein the electrical energy generated by means of the first electric machine 25 from the first drive power P1 can be fed into an electrical energy storage system of the vehicle. Some or all of the first electrical energy generated by means of the first drive power P1 can also be provided directly to the second electric machine 30. In the first operating state, the drive train 10 is thus operated as a serial hybrid.

In the first operating state, the second electric machine 30 provides a second drive power P2 at the second rotor 55, which is transmitted from the second rotor 55 to the second drive shaft 75. The second drive power P2 can be different from the first drive power P1. The second drive power P2 is transmitted to the separating clutch 200 via the second transmission means 195. The separating clutch 200 is engaged and connects the second transmission means 195 to the intermediate shaft 135. The intermediate shaft 135 transmits the second drive power P2 to the output side 80 via the second fixed gear 165. At the output side 80, the second drive power P2 is transmitted to the differential gear 185 of the differential 65. The differential 65 distributes the second drive power P2 to the output shafts 190 for driving the motor vehicle.

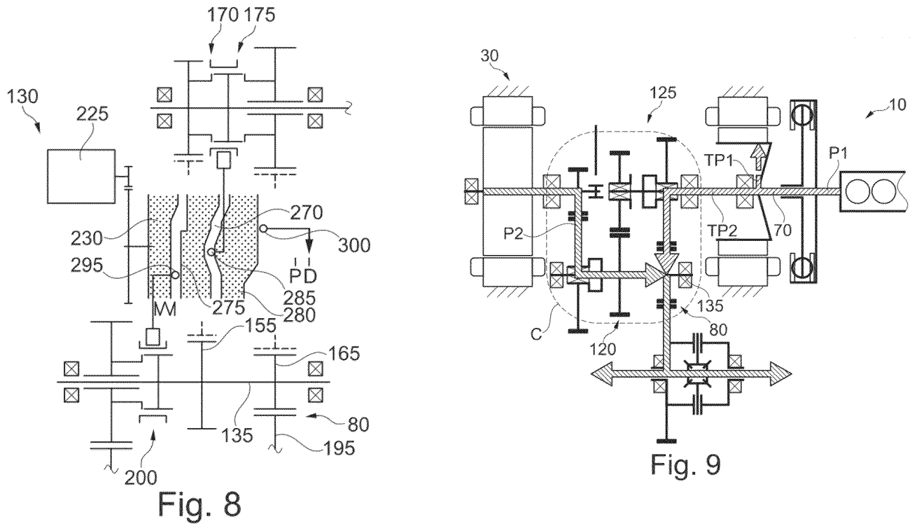

FIG. 6 shows the schematic structure of the drive train 10 shown in FIG. 1 in a second operating state. FIG. 7 shows the state of the parking lock 265, the first and second clutch 170, 175 and the separating clutch 200 in a symbolized manner. FIG. 8 shows a section B shown in FIG. 6 of the schematic representation of the drive train 10 shown in FIG. 6 during the second operating state.

In the second operating state, the parking lock 265 is disengaged. The shifting means 130 is in the first shifting state, so that the first clutch 170 is disengaged and the second clutch 175 is engaged. The separating clutch 200 is also engaged in the first shifting state.

In the second operating state, the internal combustion engine 20 provides the first drive power P1 at the crankshaft 40, wherein the first drive power P1 is transmitted to the first drive shaft 70 via the damper system 35. A first portion TP1 of the first drive power P1 is transmitted from the first drive shaft 70 to the first electric machine 25 via the rotor carrier 95, wherein the first electric machine 25 is operated as a generator. Electrical energy is generated from the first portion TP1 of the first drive power P1, which can be fed into the electrical energy storage system, for example. A second portion TP2 of the first drive power P1 is transmitted from the first drive shaft 70 to the first idler gear 150 via the first engaged clutch 170. The second portion TP2 of the first drive power P1 is transmitted from the first idler gear 150 to the first fixed gear 155, changing the speed and torque according to the first transmission ratio. The first fixed gear 155 drives the intermediate shaft 135.

In the second operating state, the drive train 10 is operated as a parallel hybrid. Here, the second electric machine 30 is operated as a motor. The second rotor 55 provides the second drive power P2, wherein the second drive power P2 is transmitted directly from the second rotor 55 to the second drive shaft 75. Through the engaged separating clutch 200, the second drive power P2 is transmitted to the second separating clutch 200 via the second transmission means 195, wherein the second separating clutch 200 introduces the second drive power P2 into the intermediate shaft 135. The intermediate shaft 135 thus acts as a summing element for the second drive power P2 and the second portion TP2 of the first drive power P1. The sum of the second drive power P2 and the second portion TP2 of the first drive power P1 is transmitted from the intermediate shaft 135 to the output side 80 via the second fixed gear 165. From the output side 80, the sum of the second drive power P2 and the second portion TP2 of the first drive power P1 is transmitted to the differential 65 for driving the vehicle via the output shafts 190.

As already explained in the context of FIG. 3, the second operating state and the corresponding setting of the parking lock 265, the first and second clutches 170, 175 and the separating clutch 200 are achieved by a corresponding rotation of the shift drum 230 by the actuator 225. Compared to FIG. 3, the shift drum 230 in FIG. 8 is rotated in the circumferential direction so that the respective link blocks 285, 295, 300 engage in the respectively associated link 270, 275, 280 at a different position and, accordingly, the first clutch 170 is engaged, the second clutch 175 is disengaged, the parking lock 265 is disengaged and the separating clutch 200 is engaged.

Due to the lower first transmission ratio of the first transmission stage 120 compared to the second transmission stage 125, the internal combustion engine 20 can already be activated at a low driving speed in order to drive the vehicle. The parallel operation of the internal combustion engine 20 together with the second electric machine 30 ensures good acceleration behavior and low fuel consumption for the internal combustion engine 20. In particular, the second drive power P2 provided by the second electric machine 30 can be significantly greater than the first drive power P1, in particular the second portion TP2 of the first drive power P1.

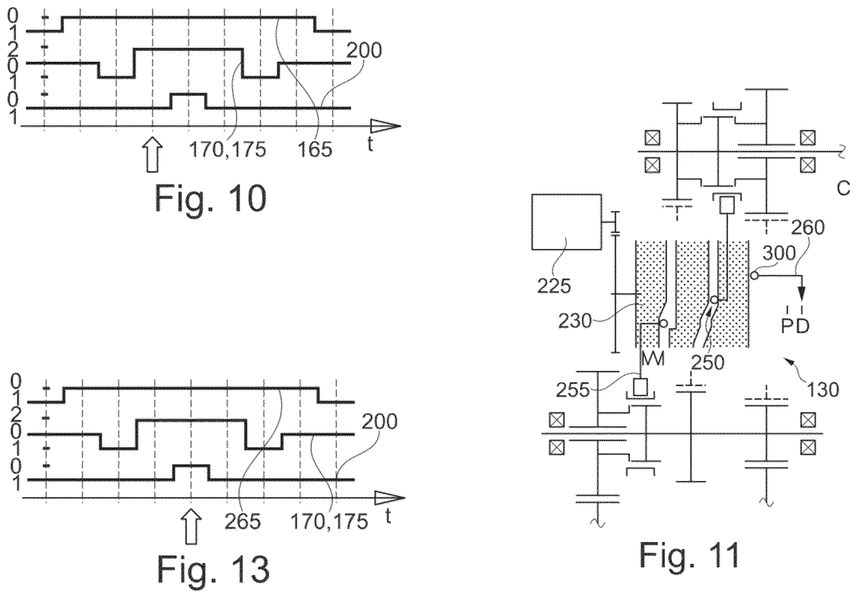

FIG. 9 shows the structure of the drive train 10 shown in FIG. 1 in a third operating state. FIG. 10 shows the state of the parking lock 265, the first and second clutch 170, 175 and the separating clutch 200 in a symbolized manner. FIG. 11 shows a section C marked in FIG. 9 of the drive train shown 10 in FIG. 9 in the third operating state.

In the third operating state, parking lock 265 is disengaged. Furthermore, the shifting means 130 is set to the second shifting state so that the second clutch 175 is engaged and the first clutch 170 is disengaged. The separating clutch 200 is engaged.

In the third operating state, the drive train 10 is operated as a parallel hybrid. In order to change to the third operating state, the shift drum 230 is rotated in the circumferential direction by the actuator 225 and the first and second clutches 170, 175, the separating clutch 200 and the parking lock 265 are set via the respective shift linkages 250, 255, 260.

The third operating state is essentially identical to the second operating state described in conjunction with FIG. 6. In the following, only the differences between the third operating state shown in FIG. 9 and the second operating state described with respect to FIGS. 6 to 8 will be discussed. In the third operating state, the drive train 10 is operated with the second transmission stage 125 instead of the first transmission stage 120 set in FIG. 6. Thus, the second portion TP2 of the first drive power P1 is transmitted from the first drive shaft 70 to the intermediate shaft 135 to the output side 80 via the second transmission stage 125 instead of via the first transmission stage 120. The intermediate shaft 135 also serves as a summing element for summing up the second drive power P2 coming from the second electric machine 30 and the second portion TP2 of the first drive power P1 transmitted via the second transmission stage 125.

Due to the higher second transmission ratio compared to the first transmission ratio, the third operating mode is particularly suitable for high speeds and in particular for dynamic acceleration of the vehicle at high speeds (for example >50 km/h).

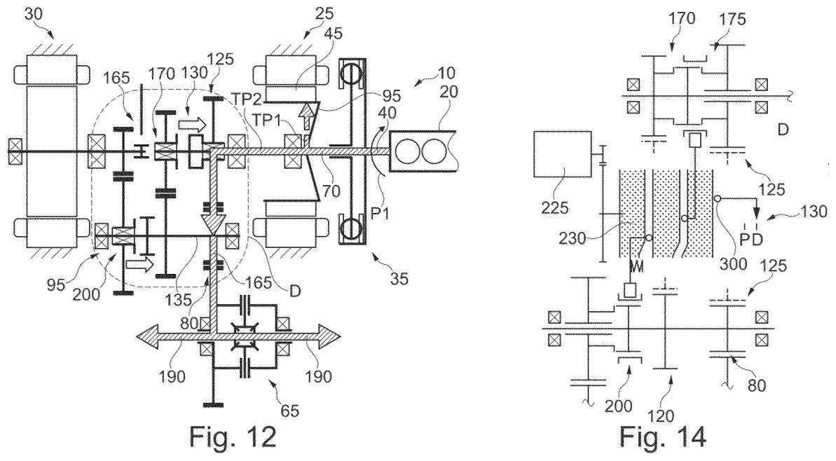

FIG. 12 shows the drive train 10 shown in FIG. 1 in a fourth operating state. FIG. 13 shows the state of the parking lock 265, the first and second clutch 170, 175 and the separating clutch 200 in the fourth operating state in a symbolized manner. FIG. 14 shows a section D marked in FIG. 12 of the drive train 10 shown in FIG. 12 in the fourth operating state.

In the fourth operating state, the shifting means 130 is set to a fourth shifting state. The fourth shifting state essentially corresponds to the second shifting state, so that the first clutch 170 is disengaged and the second clutch 175 is engaged. Furthermore, the separating clutch 200 is disengaged.

In the fourth operating state, the second electric machine 30 is deactivated. The first electric machine 25 is set to operate as a generator. The internal combustion engine 20 provides the first drive power P1 at the crankshaft 40, which is introduced into the first drive shaft 70 via the damper system 35. The first portion TP1 of the first drive power P1 is transmitted to the first rotor 45 via the rotor carrier 95. The first electric machine 25 generates electrical energy by means of the first portion TP1 of the first drive power P1, which is fed into the electrical energy storage system. The second portion TP2 of the first drive power P1 is transmitted from the first drive shaft 70 to the second clutch 175. Due to the engaged state of the second clutch 175, the hybrid transmission 15 is set to the second transmission stage 125. The second portion TP2 of the first drive power P1 is transmitted via the second transmission stage 125 with the second transmission ratio to the second fixed gear 165 on the intermediate shaft 135. The second portion TP2 of the first drive power P1 is provided at the output side 80. The second portion TP2 of the first drive power P1 is used to drive the output shafts 190 via the differential 65 in order to drive the motor vehicle. The fourth operating state has the advantage that the internal combustion engine 20 can be operated in an optimum operating range by selecting the first portion TP1 of the first drive power P1. Furthermore, this allows the electrical energy storage system of the vehicle to be recharged with the first portion TP1 of the first drive power P1.

The position of the shift drum 230 in the circumferential direction is different from the first to the third operating state. By disengaging the separating clutch 200, lugging of the second electric machine 30 via the second torque transmission path 90 is avoided. This allows the internal combustion engine 20 to be operated in a particularly energy-efficient manner with low fuel consumption.

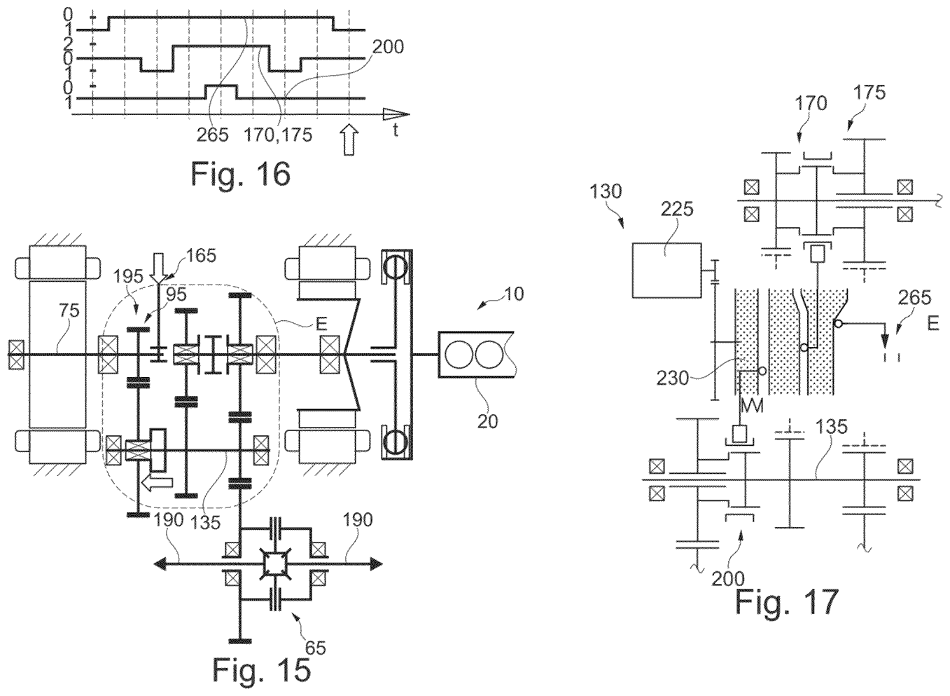

FIG. 15 shows the schematic representation of the drive train 10 shown in FIG. 1 in a fifth operating state. FIG. 16 shows a schematic representation of the state of the parking lock 265, the first and second clutch 170, 175 and the separating clutch 200. FIG. 17 shows a section E marked in FIG. 15 of the drive train 10 shown in FIG. 15.

In FIGS. 15 to 17, the parking lock 265 is engaged in the fifth operating state. Furthermore, the shifting means 130 is set to a fifth shifting state, which essentially corresponds to the first shifting state. The first clutch 170 and the second clutch 175 are disengaged. Furthermore, the separating clutch 200 is engaged.

In the fifth operating state, the drive train 10 is in parking mode. The internal combustion engine 20 is deactivated. Due to the engaged separating clutch 200, the second torque transmission path 90 is closed and the second transmission means 195 connects the second drive shaft 75 to the intermediate shaft 135 in a rotationally fixed manner. The intermediate shaft 135 is, in turn, connected to the output shaft 190 via the differential 65. The parking lock 265 connects the second drive shaft 75 to the housing 266 so that the second drive shaft 75 is blocked from rotating. As a result, rotation of the output shafts 190 is blocked via the parking lock 265 and the engaged second clutch 175.

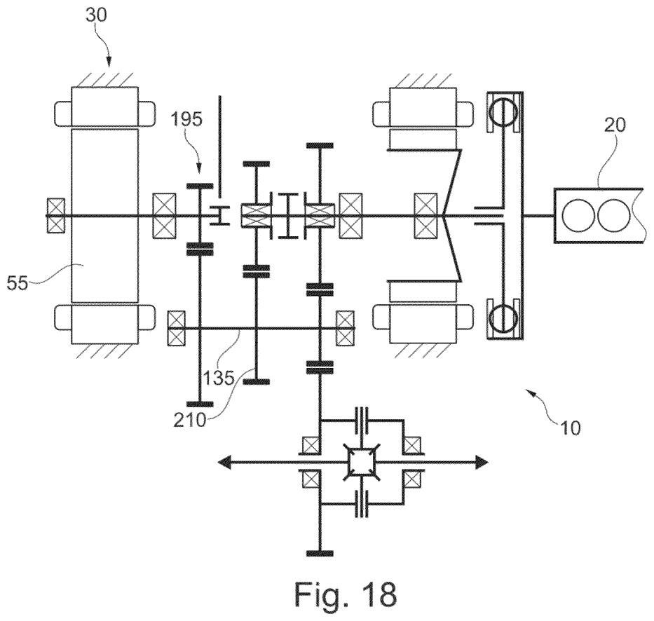

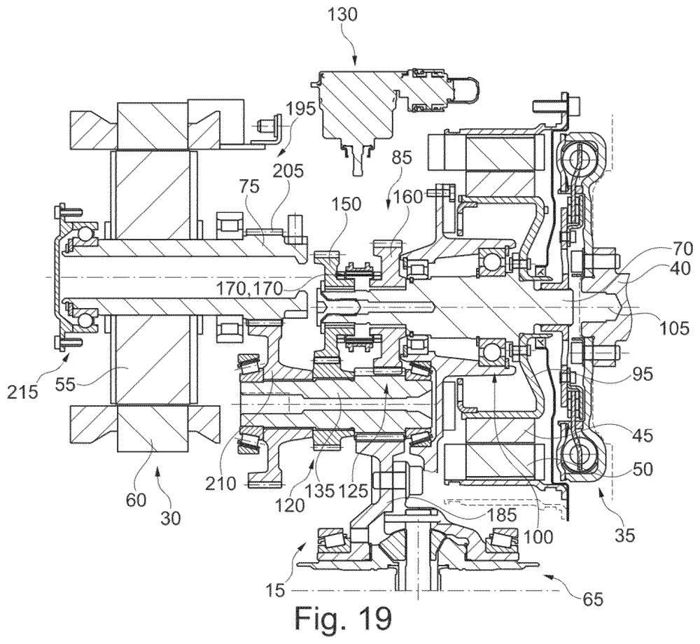

FIG. 18 shows a schematic representation of a drive train 10 according to a second embodiment. FIG. 19 shows a sectional view through a structural embodiment of the drive train 10 shown in FIG. 18.

The drive train 10 is essentially identical to the drive train 10 according to a first embodiment shown in FIGS. 1 and 2. In the following, only the differences between the drive train 10 shown in FIG. 18 and the drive train 10 shown in FIGS. 1 and 2 will be discussed.

Compared to FIGS. 1 to 17, the separating clutch 200 is omitted in FIGS. 18 and 19, so that the third idler gear 210 designated in FIGS. 1 to 17 is arranged in a rotationally fixed manner on the intermediate shaft 135 and thus the third idler gear 210 designated in FIGS. 1 to 17 functions as the fourth fixed gear in FIGS. 18 and 19. The mode of operation and the various operating states can be employed analogously to the embodiment shown in FIGS. 1 to 14, wherein in the fourth operating state, the second rotor 55 is connected in a rotationally fixed manner to the intermediate shaft 135 via the second transmission means 195 due to the separating clutch 200 not being present. As a result, the internal combustion engine 20 also has to lug the second electric machine 30 in the fourth operating state.

It is of particular advantage in FIGS. 1 to 19 that when changing the operating state and thus when actuating the first and second clutches 170, 175 and the separating clutch 200 (if present), the components to be coupled in each case must be synchronized. This can be achieved using mechanical synchronization means in the first clutch 170 and/or the second clutch 175 and/or the separating clutch 200. Additionally or alternatively, it is also conceivable that a differential speed between the components to be coupled is kept as low as possible or is already brought to an identical speed via a corresponding control of the first and/or second electric machine 25, 30.

The embodiments of the drive train 10 described above and the various operating states of the drive train 10 have the advantage that, on the one hand, the drive train 10 has a particularly simple and cost-effective mechanical design. Furthermore, the number of components can be kept particularly low so that internal frictional losses in the hybrid transmission 15 can be kept to a minimum. By using a claw clutch for the first and/or second clutch 170, 175 and/or the separating clutch 200, a particularly cost-effective clutch that is particularly low-wear can be used.

Furthermore, only one actuator 225 is required as provided by the shifting means 130 in order to set the first and second clutches 170, 175 and, if applicable, the separating clutch 200 and the parking lock 265. This further contributes to a particularly simple design of the hybrid transmission 15. In a further development of the embodiment of the drive train 10 shown in FIGS. 1 to 19, the damper system 35 can be arranged radially on the inside of the rotor carrier 95, for example, so that the axial installation space requirement of the drive train 10 is further reduced. If necessary, an optional slip clutch can be integrated into the damper system 35 so that an overload of the hybrid transmission 15 is avoided. This allows the hybrid transmission 15 to be protected from impact torques in particular.

In order to further increase the shifting quality, further synchronization means, for example synchronizer rings and/or locking rings, can be provided in addition to the synchronization and reduction of speed differences via the electric machine 25, 30. These can be designed in the same way as synchronized manual transmissions, for example.

By actuating the first clutch 170 and the second clutch 175 in an alternating manner, it is ensured that both clutches 170, 175 are not accidentally engaged. This can prevent control errors that could lead to the destruction of the hybrid transmission 15.

It should also be noted that the first operating state of the drive train 10 is also suitable for turning off the internal combustion engine 20. Regarding the design of the first and second electric machines 25, 30, the second electric machine 30 is preferably designed to be more powerful than the first electric machine 25. In particular, an especially powerful second electric machine 30 can ensure a drive train 10 with particularly favorable driving dynamics.

### LIST OF REFERENCE SYMBOLS

10 Drive train
15 Hybrid transmission
20 Internal combustion engine
25 First electric machine
30 Second electric machine
35 Damper system
40 Crankshaft
45 First rotor
50 First stator
55 Second rotor
60 Second stator
65 Differential
70 First drive shaft
75 Second drive shaft
80 Output side
85 First torque transmission path
90 Second torque transmission path
95 Rotor carrier
100 First bearing arrangement
105 First axis of rotation
110 Spring element
115 First transmission means
120 First transmission stage
125 Second transmission stage
130 Shifting means
135 Intermediate shaft
140 Second bearing arrangement
145 Second axis of rotation
150 First idler gear
155 First fixed gear
160 Second idler gear
165 Second fixed gear
170 First clutch
175 Second clutch
180 Actuation unit
185 Differential gear
190 Output shaft
195 Second transmission means
200 Separating clutch
205 Third fixed gear
210 Third idler gear
215 Third bearing arrangement
220 Third axis of rotation
225 Actuator
230 Shift drum
235 Actuating link
240 First shift fork
245 Second shift fork
250 First shift linkage
255 Second shift linkage
260 Third shift linkage
261 Drum axis
265 Parking lock
266 Housing
270 First link
275 Second link
280 Third link
285 First link block
290 End face
295 Second link block
300 Third link block
P1 First drive power
P2 Second drive power
TP1 First portion (of the first drive power)
TP2 Second portion (of the first drive power)

1. A hybrid transmission for a drive train of a hybrid vehicle, comprising:
a first drive shaft, a second drive shaft, an output side, and a first torque transmission path extending between the first drive shaft and the output side,
wherein the first torque transmission path has a first transmission means,
wherein the first drive shaft can be connected in a rotationally fixed manner to a first rotor of a first electric machine, and in a torque-locking manner, to a crankshaft of an internal combustion engine, and the second drive shaft can be connected in a rotationally fixed manner to a second rotor of a second electric machine,
wherein the first transmission means has a shifting means, a first transmission stage with a first transmission ratio, and a second transmission stage with a second transmission ratio different from the first transmission ratio,
wherein in a first shifting state of the shifting means, the shifting means connects the first drive shaft to the first transmission stage, and the first transmission stage couples the first drive shaft to the output side,
wherein in a second shifting state of the shifting means different from the first shifting state, the shifting means connects the first drive shaft to the second transmission stage, and the second transmission stage couples the first drive shaft to the output side.

2. The hybrid transmission according to claim 1,
wherein the shifting means has a first clutch, and a second clutch,
wherein, in the first shifting state, the first clutch is engaged and connects the first drive shaft to the first transmission stage in a torque-locking manner,
wherein the second clutch is disengaged in the first shifting state,
wherein, in the second shifting state, the second clutch is engaged and connects the first drive shaft to the second transmission stage in a torque-locking manner, and
wherein the first clutch is disengaged in the second shifting state.

3. The hybrid transmission according to claim 2,
wherein the shifting means has an electrically and/or hydraulically actuated actuator, a shift drum connected to the actuator, an actuating link and at least a first shift linkage,
wherein the actuating link has a first link arranged on the shift drum and at least one first link block arranged on the first link and connected to the first shift linkage,
wherein the first link block is coupled to the first clutch by means of the first shift linkage,
wherein the shift drum is arranged so as to be rotatable about a drum axis, and
wherein, in the second shifting state, the shift drum is rotated relative to the first shifting state.

4. The hybrid transmission according to claim 1,
further comprising a second torque transmission path extending between the second drive shaft and the output side with a second transmission means and a separating clutch,
wherein the separating clutch is arranged between the second transmission means and the output side, and
wherein, in a disengaged state of the separating clutch, the separating clutch separates the output side from the second transmission means and, in an engaged state of the separating clutch, the separating clutch connects the second transmission means to the output side in a torque-locking manner, preferably in a rotationally fixed manner.

5. The hybrid transmission according to claim 2,
wherein the first drive shaft is mounted rotatably about a first axis of rotation,
wherein the first transmission means has a first idler gear mounted rotatably about the first axis of rotation and a second idler gear mounted rotatably about the first axis of rotation,
wherein the shifting means is arranged axially relative to the first axis of rotation between the first idler gear and the second idler gear,
wherein the first clutch, in the engaged state, connects the first drive shaft to the first idler gear in a torque-locking manner, preferably in a rotationally fixed manner, and
wherein the second clutch, in the engaged state, connects the second idler gear to the first drive shaft in a torque-locking manner.

6. The hybrid transmission according to claim 5,
wherein the first transmission means has an intermediate shaft mounted rotatably about a second axis of rotation extending parallel to the first axis of rotation, a first fixed gear and a second fixed gear,
wherein the first fixed gear and the second fixed gear are each connected in a rotationally fixed manner to the intermediate shaft,
wherein the first idler gear and the first fixed gear engage with one another in a meshing manner, and
wherein the second idler gear and the second fixed gear engage with one another in a meshing manner.

7. The hybrid transmission according to claim 1,
further comprising a parking lock and a housing,
wherein the parking lock can be set to a disengaged state and an engaged state,
wherein the parking lock, in the engaged state, connects the second drive shaft to the housing and blocks a rotation of the second drive shaft,
wherein in the disengaged state of the parking lock, the second drive shaft is rotatable about a third axis of rotation.

8. A drive train for a hybrid vehicle, comprising:
a hybrid transmission according to claim 1, a first electric machine with a first rotor, and a second electric machine with a second rotor,
wherein the first drive shaft can be coupled to a crankshaft of an internal combustion engine,
wherein the first drive shaft is connected in a rotationally fixed manner to the first rotor and the second drive shaft is connected in a rotationally fixed manner to the second rotor,
wherein the first transmission means is arranged between the first rotor and the second rotor.

9. A method for operating a drive train according to claim 8, comprising:
introducing a first drive power into the first drive shaft,
operating the first electric machine as a generator by means of a first portion of the first drive power for generating electrical energy,
setting the shifting means to the first shifting state,
transmitting a second portion of the first drive power to the output side via the first transmission stage,
or
setting the shifting means to the second shifting state,
transmitting a second portion of the first drive power to the output side via the second transmission stage.

10. The method according to claim 9,
wherein the second electric machine introduces a second drive power into the second drive shaft,
wherein the second drive power is transmitted to the output side via the second torque transmission path,
wherein the second portion of the first drive power and the second drive power are provided at the output side for driving the vehicle.
